(19) United States
(12) Patent Application Publication
(10) Pub. No.: US 2015/0013249 A1
(43) Pub. Date: Jan. 15, 2015

(54) Door Jamb Security Fixture

(71) Applicants: Bruce S. Nielsen, Diamond Springs, CA (US); Kyle P. Nielsen, Diamond Springs, CA (US)

(72) Inventors: Bruce S. Nielsen, Diamond Springs, CA (US); Kyle P. Nielsen, Diamond Springs, CA (US)

(21) Appl. No.: 14/330,760

(22) Filed: Jul. 14, 2014

Related U.S. Application Data
(60) Provisional application No. 61/845,810, filed on Jul. 12, 2013.

(51) Int. Cl. E05B 15/02; E06B 1/52

(52) U.S. Cl. CPC E05B 15/0205; E06B 1/52
USPC 52/213; 292/340

(57) ABSTRACT

A door jamb assembly with improved aesthetics and security includes a strike plate and at least one bolt hole in the strike plate that engages a bolt. The assembly further includes a door jamb and a recessed portion on a stud side of the door jamb. The recessed portion is dimensioned to provide clearance for the strike plate so that the strike plate is substantially disposed within the door jamb when the door jamb abuts a stud.

### TECHNICAL FIELD

The apparatus described herein relates to the field of building construction, more particularly, to the field of secure door construction.

### BACKGROUND

Robberies and burglaries have been a problem in civilizations throughout history. The earliest method for preventing unwanted entry into buildings was the door lock. Door locks are of ancient origin and have also existed throughout recorded history. The basic governing concept behind door locks is that a unique key is needed to align pins so that they do not interfere with movement of a latch or bolt that is inserted into a door frame.

Key locked doors present an obstacle that most people are not willing to attempt to defeat. However, determined professional criminals can easily defeat most door locks in a forced entry. This is true in part because the door jambs are made from relatively weak materials such as wood or particle board. Thus, even if the latch, lock, and bolt are strong, the door jamb can be broken allowing for unauthorized entry.

In order to overcome this problem, the strike plate was invented. The strike plate is a metal fixture that is bolted to the door jamb to interface with the bolt of the lock. Strike plates add a sturdy metal backbone to the area of the door jamb that engages the bolt, preventing someone from easily kicking the door in and breaking the jamb to enter. Strike plates on the market today mount on the visible surface of the jamb, are unattractive, and come in one hardware finish that often does not match the remainder of the door hardware. Moreover, the current strike plates have sub-optimal anti-theft performance due their exposure which allows for tampering and reduces strength. The strike plates can also create fitment problems for the door and increase the gap between door and frame because they protrude from the jamb. This increased gap creates greater security vulnerability and increases drafts, reducing the thermal insulation of the door.

There is a need in the art for an aesthetically pleasing strike plate with improved security and fitment.

### BRIEF SUMMARY

A door jamb assembly with improved aesthetics and security includes a strike plate and at least one bolt hole in the strike plate that engages a bolt. The assembly further includes a door jamb and a recessed portion on a stud side of the door jamb. The recessed portion is dimensioned to provide clearance for the strike plate so that the strike plate is substantially disposed within the door jamb when the door jamb abuts a stud.

In some embodiments, the assembly further includes: at least one plate that engages the bolt secured to the door side of the door jamb; at least two plate screws that secure the plate to the door jamb by engaging the stud; and at least two plate screw holes on the strike plate that provide clearance for the plate screws.

In some embodiments, the assembly further includes: a latch plate that engages a latch bolt secured to the door side of the door jamb; a deadbolt plate that engages a deadbolt bolt secured to the door side of the door jamb; two bolt holes that engage the latch bolt and deadbolt bolt; four plate screws that secure the plates to the door jamb by engaging the stud; and four plate screw holes on the strike plate that provide clearance for the plate screws.

In some embodiments, the assembly further includes: at least one securement screw that secures the strike plate to the door jamb and the stud; and at least one securement screw hole in the strike plate that provides clearance for the at least one securement screw. In some embodiments, the assembly further includes: seven securement screws that secure the strike plate to the door jamb and the stud; and seven securement screw holes in the strike plate that provide clearance for the securement screws. In some embodiments, two corners of the strike plate are square and two corners are radiused. In some embodiments, the strike plate is constructed from CNC machined 6061 aircraft grade aluminum.

A door jamb strike plate with improved aesthetics and security includes at least one bolt hole and at least two plate screw holes that provide clearance for latch plate or bolt plate screws. The strike plate further includes at least one screw hole that provides clearance for a securement screw that secures the strike plate to a door jamb and stud.

In some embodiments, two corners of the strike plate are square and two corners are radiused. In some embodiments, the strike plate includes two bolt holes that engage a latch bolt and a dead bolt bolt. In some embodiments, the strike plate includes four plate screw holes. In some embodiments, the strike plate includes seven securement holes. In some embodiments, the strike plate is constructed from CNC machined 6061 aircraft grade aluminum.

### BRIEF DESCRIPTION OF THE DRAWINGS

FIG. 1: is a perspective view of one embodiment of the strike plate installed in a door jamb.

FIG. 2: is an isolated isometric view of the embodiment of FIG. 1.

FIG. 3: is a front orthographic view of the embodiment of FIG. 1.

FIG. 4: is a detailed front perspective view of the embodiment of FIG. 1 installed in a door jamb.

FIG. 5: is a detailed rear perspective view of the embodiment of FIG. 1 installed in a door jamb.

FIG. 6: is an exploded perspective view of an installation of the embodiment of FIG. 1.

FIG. 7: is a sectional view of a door jamb with the embodiment of FIG. 1 installed therein, taken along line 7-7 in FIG. 1.

### DETAILED DESCRIPTION

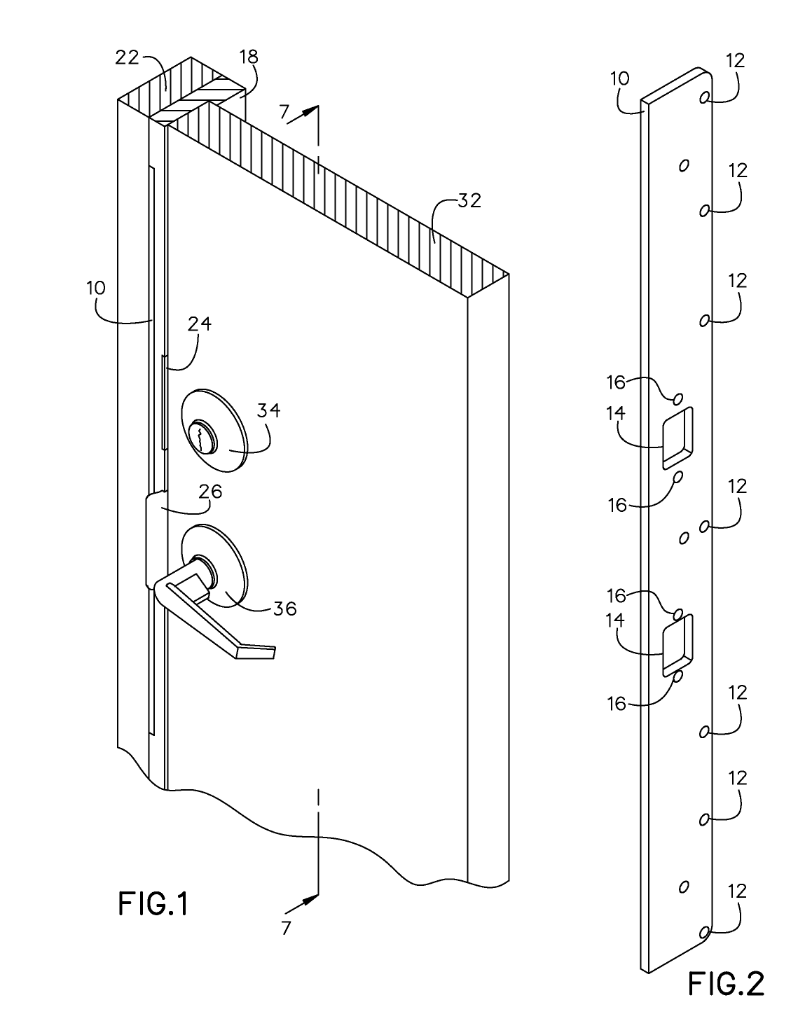

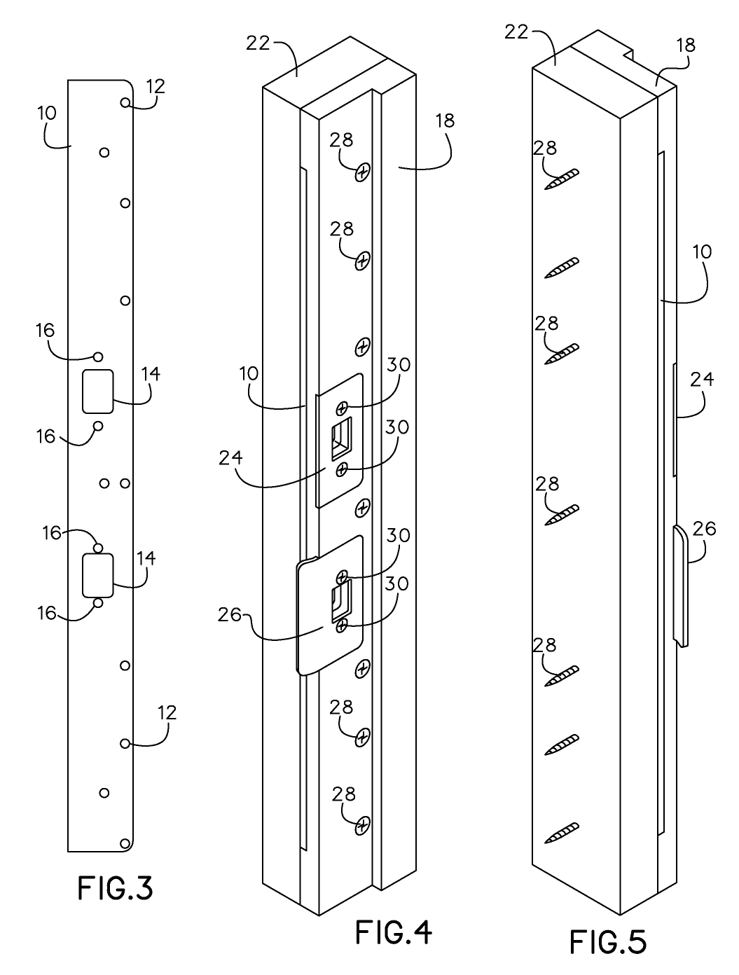

As shown in FIGS. 1-5, the strike plate 10 described herein installs between the door jamb 18 and the stud 20, on the opposite side of door jamb 18 from the door 32 (the stud side of door jamb 18). Prior strike plates are mounted on the door side of the door jamb and are often integrated with deadbolt plate 24 and latch plate 26, resulting in the disadvantages discussed in the Background. This design has the advantages of higher strength, better appearance, reduced vulnerability to tampering, and the ability to use a standard deadbolt plate 24 and latch plate 26 (which may be included with deadbolt 34 and latch 36).

In the embodiment of FIGS. 1-7, strike plate 10 has bolt holes 14 that engage the bolts 38 and 40 from latch 36 and deadbolt 34. In this embodiment, bolt holes 14 are ⅞″. This secures door 32 in a closed position with the additional strength provided by strike plate 10, which is made from a sturdier material than door jamb 18. In some embodiments, strike plate is a 2″×23½″×¼″ thick aluminum plate mortised into the back of door jamb 18. In some embodiments, strike plate 10 is CNC machined 6061 aircraft grade aluminum. In some embodiments, strike plate 10 is made of aluminum and door jamb 18 is made of wood. However, strike plate 10 may be made of other materials such as steel, polymer, or a composite material. Strike plate 10 has a variety of finishes in some embodiments to match deadbolt plate 24, latch plate 26, deadbolt 34, latch 26, and/or the door hinges.

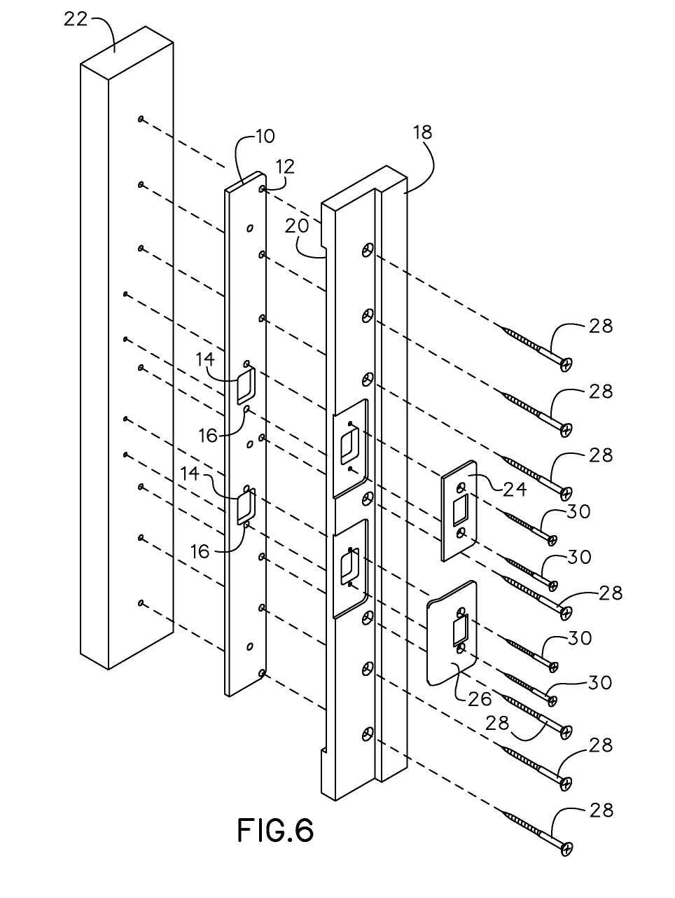

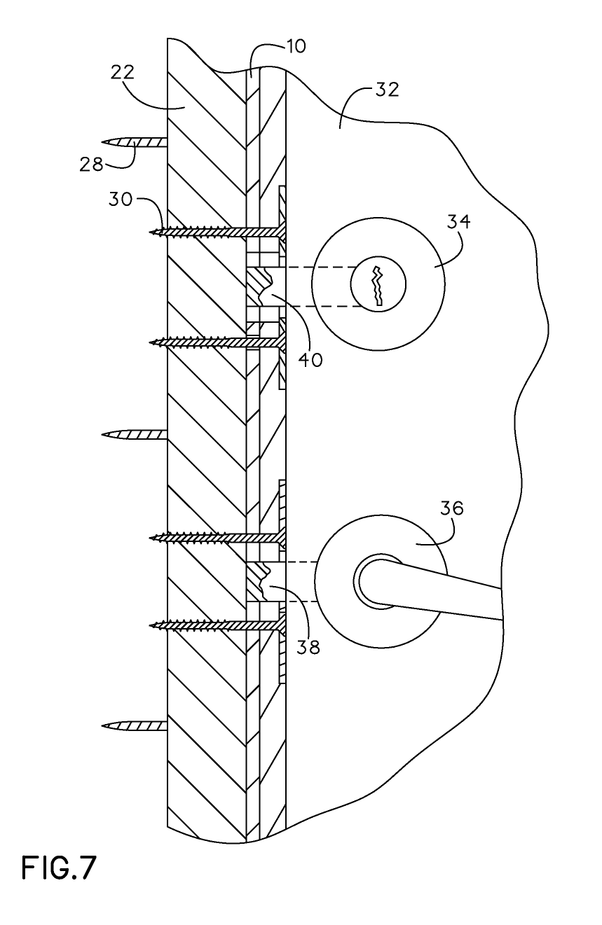

Referring now to FIGS. 6 and 7, in this embodiment, door jamb 18 is not as thick as the length of plate screws 30 for latch plate 26 and deadbolt plate 34. Therefore, strike plate 10 must have plate screw holes 16 to provide clearance for plate screws 30 so that they can engage stud 22.

Strike plate 10 is also secured to stud 22 and door jamb 18 in this embodiment. This is accomplished by providing holes in door jamb 18, through which strike plate screws 28 are inserted. In this embodiment, strike plate screws 28 are 3″ wood screws. In this embodiment, strike plate screws 28 are flush screws and the strike plate screw holes are beveled, so that strike plate screws 28 are flush with door jamb 18 when fully inserted. This prevents interference with door 32, prevents injuries and damage to clothing, and improves aesthetics. In this embodiment, strike plate screws 28 are inserted through door jamb 18 and strike plate 10 through securement holes 12, and are screwed into stud 22. In this embodiment, seven strike plate screws 28 are used, and strike plate 10 has seven securement holes 12 to ensure a secure mounting to door jamb 18 and stud 22. In this embodiment, stud 22 is a trimmer stud. In this embodiment, securement holes 12 are 3/16″.

In this embodiment, securement holes 12 are mounted on a side of strike plate 10 located close to the center of the door frame. This prevent interference with door 32 and enhances security and strength by locating screws 28 furthest from a point of forced entry.

Door jamb 18 also includes a recess 20 where strike plate 10 is installed. This allows for a flush abutment between door jamb 18 and stud 22. It further enhances strength, ease of installation, and appearance and prevents tampering. Therefore, strike plate 10 is mortised into door jamb 18. In some embodiments, recess 20 is formed by a carpenter or door shop to match the dimensions of strike plate 10. In this embodiment, the corners of strike plate 10 facing the entryway are square to be flush with the exterior surface of stud 22 and door jamb 18, while the corners facing the center of the door frame are radiused to make recess 20 easier to fabricate, and strike plate 10 easier to install.

The result of this system is a door that is aesthetically pleasing while being capable of resisting an attempt at kicking it in. In this system, strike plate 10 mounts on the back of door jamb 18, the dead bolt 40 interlocks more securely than other devices, and strike plate 10 is concealed. This creates a sandwiched effect where each layer is sturdily secured together, creating a door jamb with superior strength over prior designs.

Although the invention has been described with reference to embodiments herein, those embodiments do not limit the invention. Modifications to those embodiments or other embodiments may fall within the scope of the invention.

What is claimed is:

1. A door jamb assembly with improved aesthetics and security, comprising:
a strike plate;
at least one bolt hole in said strike plate that engages a bolt;
a door jamb; and
a recessed portion on a stud side of said door jamb;
said recessed portion being dimensioned to provide clearance for said strike plate so that said strike plate is substantially disposed within said door jamb when said door jamb abuts a stud.

2. The assembly of claim 1, further comprising:
at least one plate that engages the bolt secured to a door side of said door jamb;
at least two plate screws that secure said plate to said door jamb by engaging the stud; and
at least two plate screw holes on said strike plate that provide clearance for said plate screws.

3. The assembly of claim 2, further comprising:
a latch plate that engages a latch bolt secured to the door side of said door jamb;
a deadbolt plate that engages a deadbolt bolt secured to the door side of said door jamb;
two bolt holes that engage the latch bolt and deadbolt bolt;
four plate screws that secure said plates to said door jamb by engaging the stud; and
four plate screw holes on said strike plate that provide clearance for said plate screws.

4. The assembly of claim 1, further comprising:
at least one securement screw that secures said strike plate to said door jamb and the stud; and
at least one securement screw hole in said strike plate that provides clearance for said at least one securement screw.

5. The assembly of claim 1, further comprising:
seven securement screws that secure said strike plate to said door jamb and the stud; and
seven securement screw holes in said strike plate that provide clearance for said securement screws.

6. The assembly of claim 1, wherein two corners of said strike plate are square and two corners are radiused.

7. The assembly of claim 1, wherein said strike plate is constructed from CNC machined 6061 aircraft grade aluminum.

8. A door jamb strike plate with improved aesthetics and security, comprising:
at least one bolt hole;
at least two plate screw holes that provide clearance for latch plate or bolt plate screws; and
at least one screw hole that provides clearance for a securement screw that secures the strike plate to a door jamb and a stud.

9. The door jamb strike plate of claim 8, wherein two corners of the strike plate are square and two corners are radiused.

10. The door jamb strike plate of claim 8, comprising two bolt holes that engage a latch bolt and a dead bolt bolt.

11. The door jamb strike plate of claim 10, comprising four plate screw holes.

12. The door jamb strike plate of claim 8, comprising seven securement holes.

13. The door jamb strike plate of claim 8, wherein the strike plate is constructed from CNC machined 6061 aircraft grade aluminum.
